(19) United States
(12) Patent Application Publication
(10) Pub. No.: US 2007/0041820 A1
(43) Pub. Date: Feb. 22, 2007

(54) Fork cover having weighing capability

(76) Inventor: Gerald S. Simons, Toronto (CA)

Correspondence Address: HODGSON RUSS LLP, ONE M & T PLAZA, SUITE 2000, BUFFALO, NY, 14203-2391, US

(21) Appl. No.: 11/282,253

(22) Filed: Nov. 18, 2005

Related U.S. Application Data
(60) Provisional application No. 60/704,516, filed on Aug. 1, 2005.

(51) Int. Cl. A01D 87/08

(52) U.S. Cl. 414/647

(57) ABSTRACT

The invention includes a retrofit device providing weighing capability to a lifting fork. A device according to the invention may have a substantially U-shaped cover, a load cell, and a transmission device. A method of using the device is also disclosed.

### CROSS-REFERENCE TO RELATED APPLICATION

This application claims the benefit of priority to U.S. provisional patent application Ser. No. 60/704,516 filed on Aug. 1, 2005.

### FIELD OF THE INVENTION

The present invention relates to lifting forks having the ability to weigh objects being lifted by the forks.

### BACKGROUND OF THE INVENTION

Some vehicles are designed for specific tasks, such as lifting, lowering and/or moving heavy objects. Often such vehicles are equipped with forks designed to lift and lower the objects. Such vehicles include, for example, front loaders such as garbage trucks, stackers, reach trucks, hand pallett jacks, electric walkie trucks, front end loaders and lift trucks, which have a pair of forks that can be raised or lowered in order to raise or lower a heavy object. For example, a pallet may be loaded with goods, and the forks may be inserted into the pallet. The pallet may be lifted using the forks, and if desired, the vehicle may be driven to a location where the forks are lowered in order to set the pallet on the ground. In this fashion, the goods may be moved from one location to another.

Although there are vehicles that can weigh the object being lifted, the systems are complex and costly. Further, in order to retrofit an existing fork with weighing capability, some existing systems require replacement of the forks with specially designed forks. Alternatively, large, complex and costly devices are used to retrofit an existing fork, but these prevent entry into the 3.5 inch slots of standard pallets. What is needed is a low-cost system that will allow a vehicle to have weighing capability while utilizing standard forks.

### SUMMARY OF THE INVENTION

The present invention includes a retrofit device providing weighing capability to a lifting fork. A device according to the invention may have a substantially U-shaped cover having a rigid lifting section on which may be placed an object to be lifted. A load cell may be positioned between the rigid lifting section and the lifting fork when the cover is placed on the lifting fork. A transmission device, capable of transmitting a signal from the load cell to an analyzing circuit may be used. In such a device according to the invention, no modification of the lifting fork may be necessary to afford weighing capability via the load cell.

The invention may be embodied as a method. In one such method, a device may be provided. The device may have a substantially U-shaped cover, a load cell, and a transmission device. The cover may be placed over a lifting fork so that the load cell resides between the cover and the fork. An object may be placed on the cover, and a signal from the load cell may be transmitted via the transmission device to an analyzing circuit. The signal may be interpreted as a weight of the object, and the weight may be displayed. The method may be carried out so that no modification of the lifting fork is necessary.

### BRIEF DESCRIPTION OF THE DRAWINGS

For a fuller understanding of the nature and objects of the invention, reference should be made to the accompanying drawings and the subsequent description. Briefly, the drawings are:

FIG. 1, which is a plan view of a lift truck having two forks, each with a device according to the invention;

FIG. 2, which is a cross sectional view taken along the line 2-2 in FIG. 1;

FIG. 3, which is a cross sectional view taken along the line 3-3 in FIG. 1;

FIG. 4a, which is a plan view of a load cell according to the invention;

FIG. 4b, which is a side view of the load cell depicted in FIG. 4a;

FIG. 5, which depicts an embodiment of the invention having three load cells; and

FIG. 6, which depicts a method according to the invention.

### FURTHER DESCRIPTION OF THE INVENTION

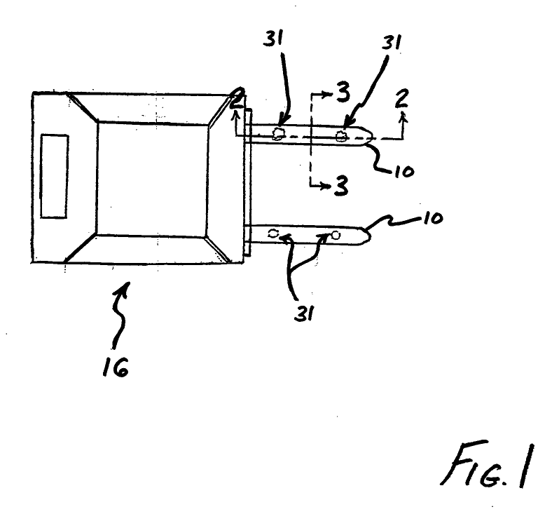

The invention may be embodied as a device 10 that can be added to an existing lifting fork 13 in order to provide weighing capability to the fork 13. As such, the invention may be used to retrofit an existing lifting fork 13 without modifying the lifting fork 13 and thereby allow a fork lift operator to know the weight being lifted by the lifting fork 13. FIG. 1 depicts a lift truck 16 having a device 10 according to the invention on each of its two lifting forks 13.

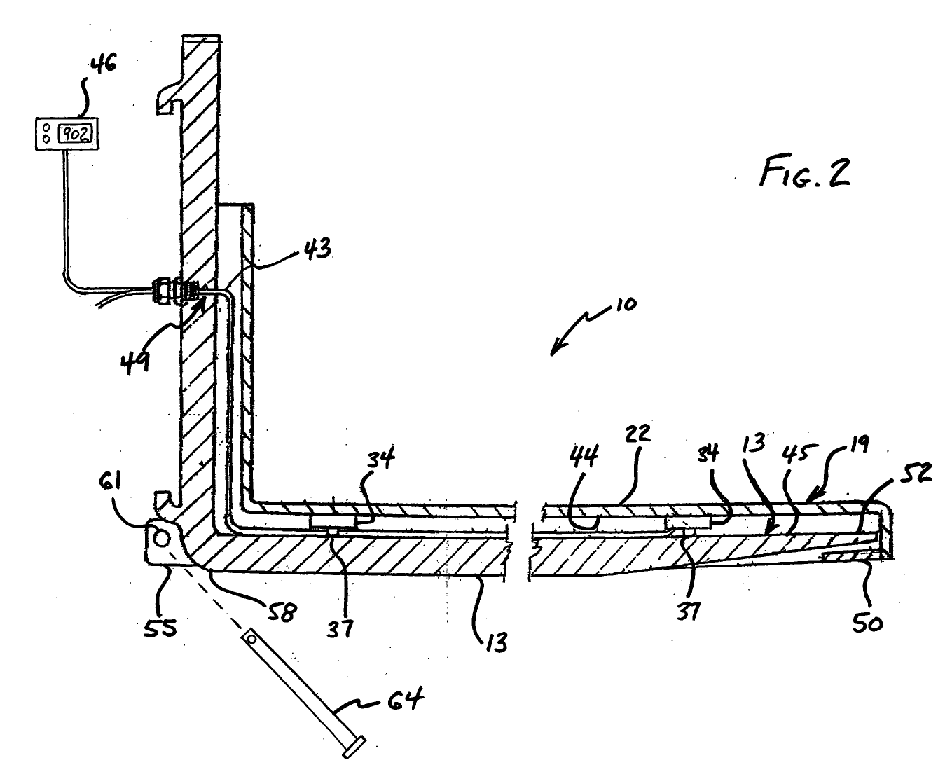

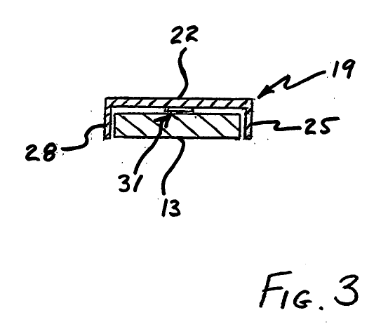

FIG. 2 is a cross-sectional view of a device 10 according to the invention mounted to a lifting fork 13. FIG. 3 is a cross-sectional view of a device 10 according to the invention mounted to a lifting fork 13. The embodiment depicted in FIGS. 2 and 3 includes a cover 19. The cover may be formed from ¼ inch thick metal plate. Over most of the length of the cover 19, the cross-section is U-shaped, which is best seen in FIG. 3. A portion of the cover 19 may be intended for contacting an object to be lifted, and that portion is referred to herein as the “rigid lifting section 22.” Objects such as a pallet may be placed on the rigid lifting section 22. Extending from the rigid lifting section 22 may be a first side section 25 and a second side section 28.

A load cell 31 may be positioned between the rigid lifting section 22 and the lifting fork 13 when the cover 19 is placed on the lifting fork 13. As used herein, the term “load cell” refers generally to devices that are capable of signaling an applied force, such as a pressure transducer or strain gauges arranged as a Wheatstone bridge. The invention is described with reference to strain gauges arranged as a Wheatstone bridge, but the invention is not limited to that type of load cell.

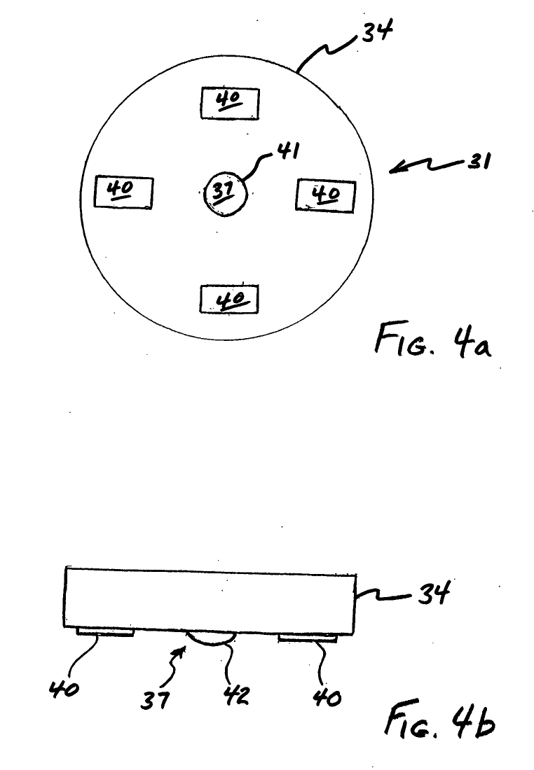

FIG. 4a and FIG. 4b show a load cell 31 that may be used with the invention. This load cell 31 may have a base 34, and extending from the base 34 may be a contact knob 37. The knob 37 may be arranged to face the lifting fork 13 when the cover 19 is placed on the lifting fork 13. The base 34 may be arranged to face the rigid lifting section 22, and may be attached to the rigid lifting section 22. In this arrangement, the fork 13 may be slid inside the cover 19 so that the contact knob 37 contacts the fork 13. The load cell 31 may have a height of about 0.3 inches, and when used with a cover 19 made from ¼ inch thick plate, the device 10 mounted to a lifting fork 13 should be able to enter a standard pallet.

A plurality of strain gauges 40 may be mounted to the base 34. In one arrangement of the load cell 31, the strain gauges 40 are located radially further from a central location of the base 34 than the edges 41 of the contact knob 37. However, it will be recognized that the strain gauges 40 need not be located around the contact knob 37 in order to practice the invention.

The contact knob 37 of the load cell 31 may include a rounded surface 42 in order to prevent twisting of the load cell 31 when the surface 44 of the cover 19, to which the load cell 31 is attached, is not parallel to the surface 45 of the fork 13, which contacts the knob 37. The rounded surface 42 of the knob 37 accommodates non-linear loading of the load cell 31, and thereby reduces signal errors normally experienced when a load cell 31 is loaded in a non-linear fashion.

Two or more load cells 31 may be used, and these may be distributed over the length of the lifting fork 13. In FIG. 1, two load cells 31 are used with each cover 19, and there is one cover 19 for each of the lifting forks 13, for a total of four load cells 31. In this manner, the weight of the object may be transferred via the load cells 31 from the covers 19 to the forks 13. The load cells 31 may be attached to the cover 19 so that when the cover 19 is placed over the lifting fork 13, the load cells 31 remain stationary relative to the cover 19. In this manner, a device 10 according to the invention may be easily installed on or removed from a lifting fork 13.

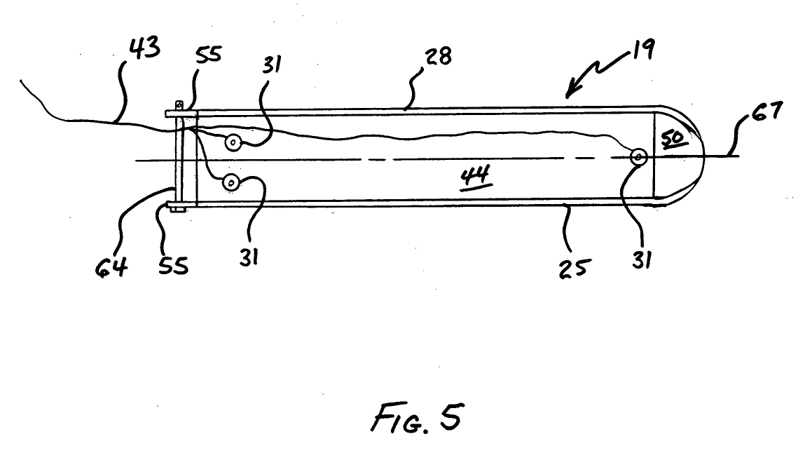

In FIG. 5 there is shown an embodiment of the invention having more than two load cells 31. In that embodiment, two load cells are placed near a heel 58 of the fork 13 and one load cell is placed near the tip 52 of the fork 13. By placing load cells 31 on either side of a longitudinal center line 67 of the cover 19, the cover 19 may be prevented from tipping side-to-side. Further, by adding load cells 31, the maximum weight that can be measured by the system can be increased.

A transmission device 43 may be included. Such a transmission device 43 may be capable of transmitting a signal from the load cell 31 to an analyzing circuit and display device 46, such as a voltmeter. The transmission device 43 may be a wire extending between the analyzing circuit 46 and the load cell 31, and the wire may be capable of transmitting electricity between the analyzing circuit 46 and the load cell 31. Such a wire may be routed from the load cell 31 and through a hole 49 in the lifting fork 13. Strain gauges 40 on each load cell 31 may be connected to the analyzing circuit to form a Wheatstone bridge, and the Wheatstone bridge may be used to detect the load being transmitted through each load cell 31. The outputs from the Wheatstone bridges may be summed to provide an indication of the weight being lifted by the forks 13, and the weight may be displayed to a driver of the lift truck 16.

The cover 19 may be held to the fork 13 via a retainer 55. The retainer 55 may extend from the cover 19 at a location proximate to a heel 58 of the lifting fork 13 when the cover 19 is placed on the lifting fork 13. The retainer 55 may have a hole 61 therethrough, and a retainer pin 64 may be inserted through the hole 61 in order to position part of the fork 13 between the pin 64 and the cover 19. FIG. 2 shows one of two retainers 55 that may be used. Each retainer 55 may be a tubular extension having holes 61 extending through the wall of the tube so that the pin 64 may be inserted and extend through the wall of the tube. Such an arrangement should allow the cover 19 to be placed quickly and easily on a standard fork, and thereby facilitates the use of a lift truck 16 with weighing capability or without weighing capability, as desired by the user. It will be recognized that other means may be used to hold the cover 19 on the fork 13.

The cover 19 may have a portion 50 that wraps around a tip 52 of the lifting fork 13. In this manner, the tip 52 of the lifting fork 13 may be enclosed by the cover 19. Such an arrangement may allow the cover 19 to be retained on the fork 13.

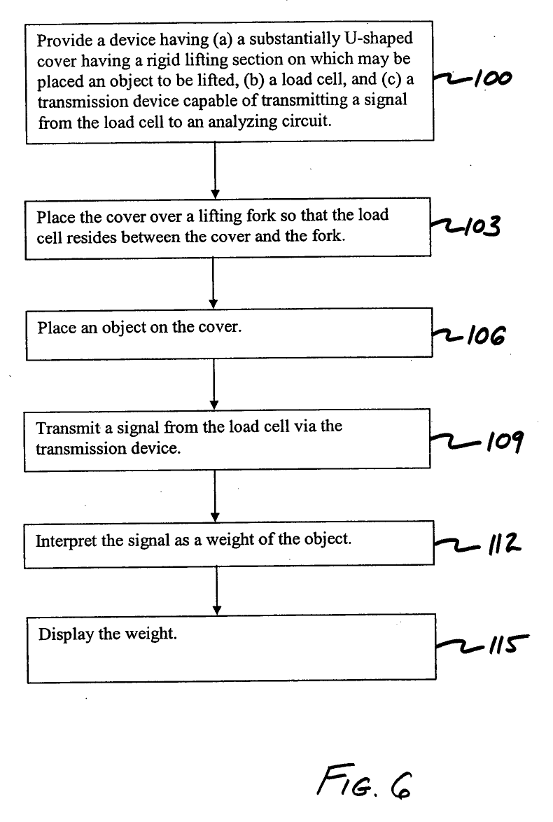

The invention may be embodied as a method. FIG. 6 depicts one such method. In that method, a fork may be retrofitted so as to provide weighing capability. A device may be provided 100. The device may include a substantially U-shaped cover having a rigid lifting section on which may be placed an object to be lifted. The device may also include a load cell and a transmission device capable of transmitting a signal from the load cell to an analyzing circuit. The cover may be placed 103 over a lifting fork so that the load cell resides between the cover and the fork. An object may be placed 106 on the cover. A signal from the load cell may be transmitted 109 via the transmission device. The signal may be interpreted 112 as a weight of the object and displayed 115 to a person. In this manner, no modification of the lifting fork is necessary to afford weighing capability via the load cell.

The method may also include providing the cover with a retainer extending from the cover. The retainer may be located proximate to a base of the lifting fork when the cover is placed on the lifting fork. An abutment, such as a pin, may be attached to the retainer so as to place a portion of the fork between the abutment and the cover.

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. A retrofit device providing weighing capability to a lifting fork, comprising:
a substantially U-shaped cover having a rigid lifting section on which may be placed an object to be lifted;
a load cell positioned between the rigid lifting section and the lifting fork when the cover is placed on the lifting fork;
a transmission device, the transmission device being capable of transmitting a signal from the load cell to an analyzing circuit;
wherein no modification of the lifting fork is necessary to afford weighing capability via the load cell.

2. The device of claim 1, wherein the cover wraps around a tip of the lifting fork.

3. The device of claim 2, wherein the cover encloses the tip of the lifting fork.

4. The device of claim 1, wherein the load cell is attached to the cover.

5. The device of claim 1, further comprising a second load cell.

6. The device of claim 5, wherein the first load cell is positioned on a first side of a center line corresponding to the cover, and the second load cell is positioned on a second side of the center line.

7. The device of claim 1, wherein the transmission device includes a wire extending between the load cell and the analyzing circuit.

8. The device of claim 1, wherein the load cell includes a base and a contact knob.

9. The device of claim 8, wherein the load cell comprises a plurality of strain gauges mounted to the base.

10. The device of claim 1, wherein the knob is arranged to face the lifting fork.

11. The device of claim 1, wherein the base is arranged to face the rigid lifting section.

12. The device of claim 1, wherein the contact knob has a rounded surface.

13. The device of claim 1, further comprising a retainer extending from the cover at a location proximate to a base of the lifting fork when the cover is placed on the lifting fork.

14. The device of claim 13, wherein the retainer has a hole therethrough, and the device further comprises a retainer pin capable of extending through the hole in the retainer.

15. A method of retrofitting a lifting fork, comprising:
providing a device having (a) a substantially U-shaped cover having a rigid lifting section on which may be placed an object to be lifted, (b) a load cell, and (c) a transmission device capable of transmitting a signal from the load cell to an analyzing circuit;
placing the cover over a lifting fork so that the load cell resides between the cover and the fork;
placing an object on the cover;
transmitting a signal from the load cell via the transmission device;
interpreting the signal as a weight of the object, wherein no modification of the lifting fork is necessary to afford weighing capability via the load cell.

16. The method of claim 15, wherein the device further includes a retainer extending from the cover at a location proximate to a base of the lifting fork when the cover is placed on the lifting fork, and attaching an abutment to the retainer so as to place a portion of the fork between the abutment and the cover.
